(19) United States
(12) Patent Application Publication
(10) Pub. No.: US 2013/0158820 A1
(43) Pub. Date: Jun. 20, 2013

(54) SAFETY SYSTEM FOR BACKING UP MOTOR VEHICLE

(71) Applicant: Pei-Cheng Chiu, Kaohsiung (TW)

(72) Inventor: Pei-Cheng Chiu, Kaohsiung (TW)

(21) Appl. No.: 13/327,762

(22) Filed: Dec. 16, 2011

(51) Int. Cl. G06F 7/00

(52) U.S. Cl. 701/51

(57) ABSTRACT

The safety system for backing up a motor vehicle contains a processing device, a switch device, and a brake control device. The processing device is connected with a gear position signal source so as to determine the motor vehicle's gear position, with a distance detection device so as to determine the presence of and distance to an obstacle along the motor vehicle's backing-up path, and with a speed detection device so as to determine the motor vehicle's speed. The processing device combines all the information and sends signals to the brake control device through the switch device to brake the motor vehicle in various manners. The driver in the meantime can be alerted about the potential hazard.

### TECHNICAL FIELD OF THE INVENTION

The present invention is generally related to the backing up of motor vehicles, and more particular to a system for providing safety measures when backing up a motor vehicle.

### DESCRIPTION OF THE PRIOR ART

Taiwan Patent No. 1329584 teaches a safety system for a motor vehicle. The safety system contains a camera and a processor. The camera captures images in front of the motor vehicle among which a vehicle base line and two horizontal mark lines running in parallel across the images are determined. The processor calculates a first distance between the vehicle base line and an adjacent horizontal mark line, and a second distance between the two horizontal mark lines. The processor then determines the distance to a vehicle ahead based on the ratio between the first and second distances. The teaching does not require precise leveling, can be easily assembled, and yet achieves superior accuracy.

However, the teaching is for monitoring the front of a motor vehicle. The rear of the motor vehicle is left unprotected, especially when backing up the motor vehicle. When there is some unexpected incident during the backing up, there is no safety means to stop the motor vehicle to prevent collision.

### SUMMARY OF THE INVENTION

The safety system for backing up a motor vehicle contains a processing device, a switch device, and a brake control device. The processing device is connected with a gear position signal source so as to determine the motor vehicle's gear position, with a distance detection device so as to determine the presence of and distance to an obstacle along the motor vehicle's backing-up path, and with a speed detection device so as to determine the motor vehicle's speed. The processing device combines all the information and sends signals to the brake control device through the switch device to brake the motor vehicle in various manners.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a functional block diagram showing a safety system according an embodiment of the present invention.

FIG. 2 is a functional block diagram showing a safety system according another embodiment of the present invention.

FIG. 3 is a functional block diagram showing a safety system according yet another embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

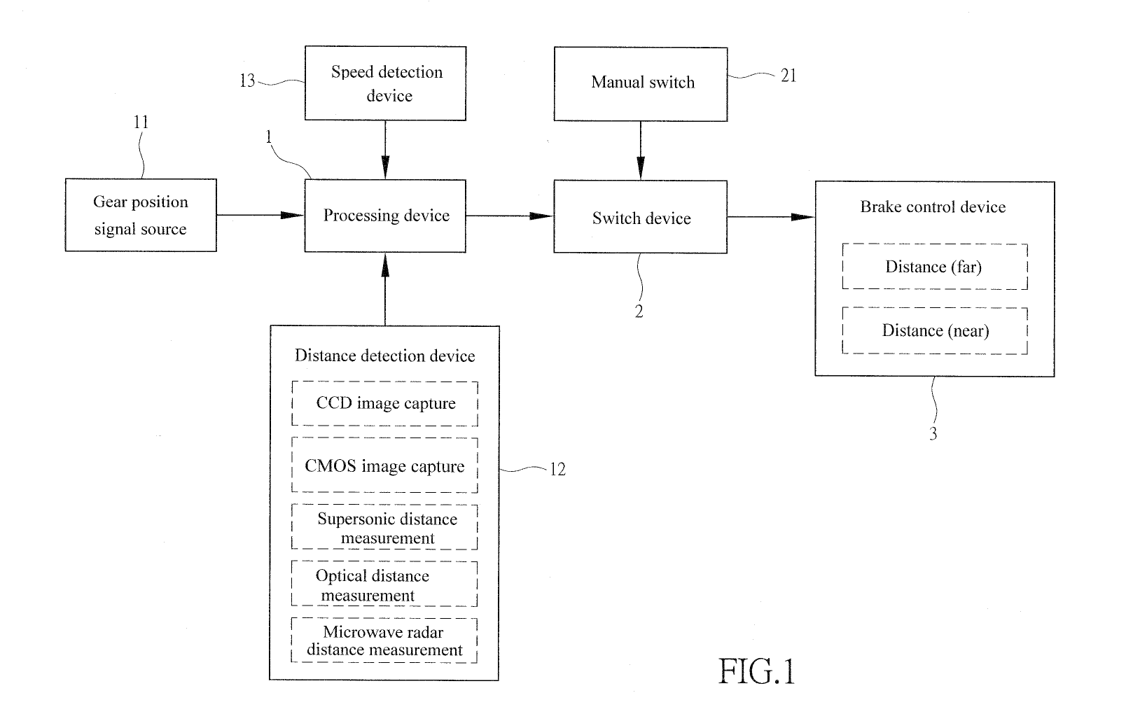

As shown in FIG. 1, the safety system for backing up a motor vehicle contains a processing device 1, a switch device 2, and a brake control device 3.

The processing device 1 is connected to a gear position signal source 11 and thereby is capable of detecting the gear position of the motor vehicle. The processing device 1 is also connected to a distance detection device 12 for measuring the distance between the motor vehicle and an obstacle. Additionally, the processing device 1 is connected to a speed detection device 13 for measuring the speed of the motor vehicle. When the processing device 1 detects that the motor vehicle is in reversed gear, the distance detection device 12 determines whether there is an obstacle in the motor vehicle's path and, when the distance between the obstacle and the motor vehicle is within a specified distance, the processing device 1 would produce a signal. As the distance changes, the processing device 1 would vary the signal correspondingly.

The switch device 2 receives the signal from the processing device 1 and delivers the signal to the brake control device 3. On the other hand, the switch device 2 is connected to a manual switch 21 so that the signal delivery from the switch device 2 to the brake control device 3 can be manually shut down.

The brake control device 3 is connected to the brake system of the motor vehicle. After receiving the signal from the switch device 2, the brake control device 3 can activate the motor vehicle's brake system and force the motor vehicle to brake. Additionally, depending on the received signal, the brake system could be activated to exercise various brake modes.

When the motor vehicle is put into reversed gear, the processing device 1 would detect that from the gear position signal source 11 immediately. The distance detection device 2 is then activated and, once an obstacle in the path of the motor vehicle is detected, relevant information is delivered to the processing device 1 for analysis. The distance detection device 12 could be implemented using one of the following means: CCD (Charge Couple Device) image capture, CMOS (complementary Metal-Oxide Semiconductor) image capture, microwave radar distance measurement, supersonic distance measurement, and optical distance measurement.

Then, when a detected obstacle is within a specified distance, the processing device 1 outputs a signal to the switch device 2, which delivers the signal to the brake control device 3. The brake control device 3 activates the brake system of the motor vehicle to exercise an initial braking mode which brakes the motor vehicle intermittently. As such, the motor vehicle shakes and the driver is alerted about the presence of the obstacle.

As the motor vehicle moves and the distance to the obstacle shortens, the processing device 1 alters the signal correspondingly. As such, a different braking mode is exercised by the brake control system 3 such as continuously braking the motor vehicle to stop. If the distance to the obstacle is already short enough when the motor vehicle is put into reverse, the brake control system 3 could directly brake the motor vehicle to stop so as to maintain the maximum safety.

Furthermore, as the safe braking distance is significantly related to the speed of the motor vehicle, the processing device 1 can detect the speed of backing up the motor vehicle through the speed detection device 13. The processing device 1 then calculates the safe braking distance in accordance with the current speed and outputs a corresponding signal so as to activate the brake control system 3 into an appropriate braking mode.

When the motor vehicle is put into reverse under normal circumstance and an obstacle is detected by the distance detection device 12, a driver is able to set the manual switch 21 so as to shut down the switch device 2 and thereby the brake control device 3. Then, the backing up of the motor vehicle can be continued. On the other hand, after the backing up is completed and the gear is detected to be out of the reverse through the gear position signal source 11, or after the engine stops, the processing device 1 automatically shuts down the switch device 2 and thereby the brake control device 3, so that the motor vehicle can be operated normally. To maintain the safety of backing up motor vehicle, if the backing-up speed has reached a specified threshold and is detected by the speed detection device 13, the processing device 1 can force the switch device 2 to open and force the brake control device 3 to brake the motor vehicle.

The manual switch 21 could be further connected to the brake system of the motor vehicle so that, to operate the manual switch 21, the brake system should already be in operation. In other words, the motor vehicle has to be fully braked and halted before the manual switch 21 can be effectively operated. This can prevent the manual switch 21 from being accidentally engaged.

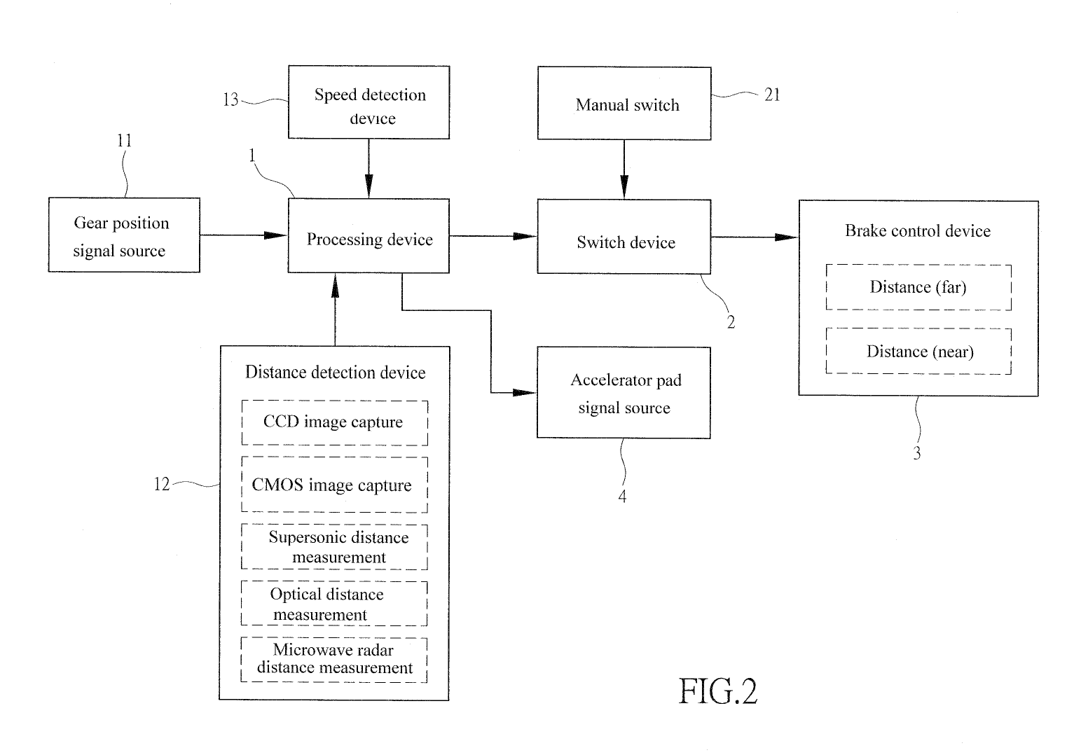

In an alternative embodiment as shown in FIG. 2, to perfect the present invention, the processing device 1 can be further connected to an accelerator pedal signal source 4 and blocks the signal from the accelerator pedal signal source 4. The motor vehicle is therefore prevented from acceleration even though the accelerator pedal is floored. According to the invention, when the processing device 1 engages the brake control device 3 to function, the processing device 1 also stops the fuel provision to the engine so that braking the motor vehicle is effectively carried out. Additionally, the blocking of the signal from the accelerator pad signal source 4 could be in an intermittent manner or in a continuous manner, so as to be compatible with the intermittent or continuous braking mode exerted by the brake control device 3.

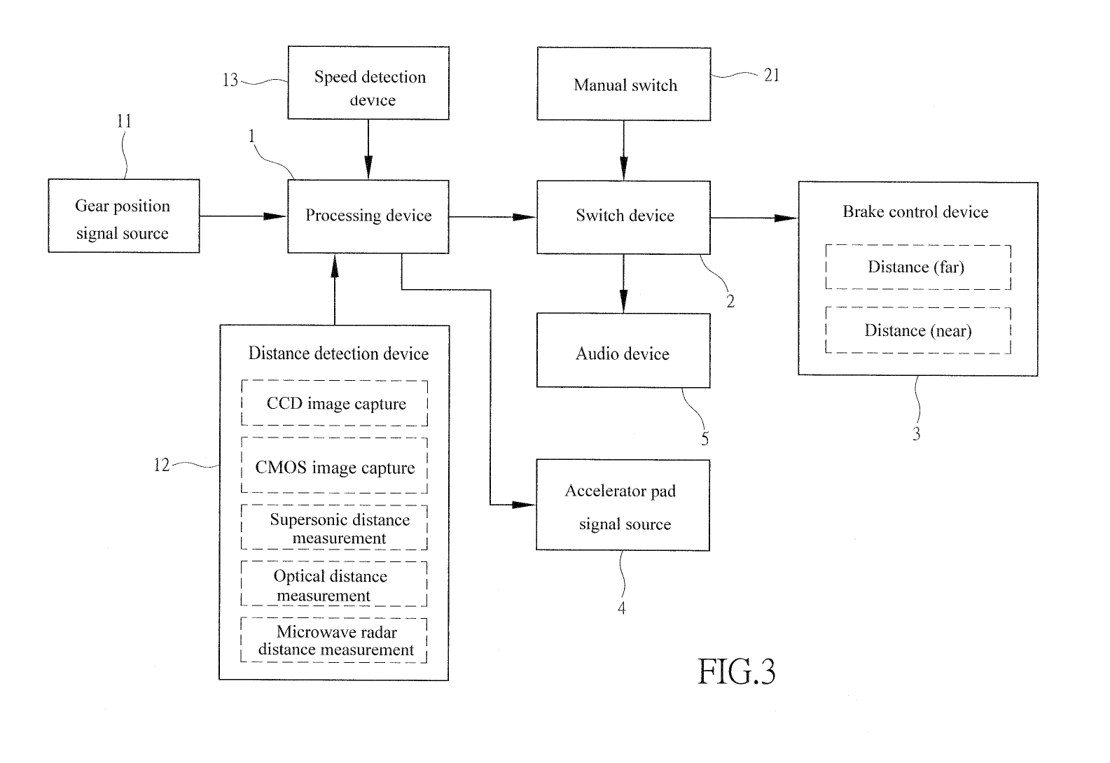

In another alternative embodiment as shown in FIG. 3, the switch device 2 can be further connected to an audio device 5 capable of issuing an alarming source or warning voice message. When the motor vehicle is put in reverse and an obstacle is present within an effective range along the path, the processing device 1 sends a signal to the audio device 5 through the switch device 2 and the audio device 5 plays the alarming sound or voice message so that the driver is alerted. Furthermore, depending on the distance to the obstacle, the processing device 1 can send different signals and the audio device 5 can as such vary the volume, frequency, rhythm, message content, etc. Or, depending on the braking process by the brake control device 3, the processing device 1 can send different signals and the audio device 5 can vary the alarming sound and voice message correspondingly.

In summary, the present invention relies on the connection of the processing device 1 with the gear position signal source 11 so as to determine the motor vehicle's gear position, with the distance detection device 12 so as to determine the presence of and distance to an obstacle along the motor vehicle's backing-up path, and with the speed detection device 13 so as to determine the motor vehicle's speed, the present invention's processing device 1 combines all the information and sends signals to the brake control device 3 through the switch device 2 to brake the motor vehicle in various manners. The driver in the meantime can be alerted about the potential hazard.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A safety system for backing up a motor vehicle, comprising:
a processing device connected to a gear position signal source of said motor vehicle so as to obtain a gear position of a motor vehicle;
a distance detection device detecting the presence of and a distance to an obstacle in an effective range along a backing-up path of said motor vehicle, said processing device connected to said distance detection device wherein, when said motor vehicle is in reverse and an obstacle is detected in a specified distance, said processing device produces a signal;
a speed detection device detecting a backing-up speed of said motor vehicle, with which said processing device calculates a safe braking distance and produces a different signal to separately activate said brake control device as an additional measure of safety;
a brake control device connected to a brake system of said motor vehicle; and
a switch device receiving said signal from said processing device and delivering said signal to said brake control device, wherein said signal activates said brake control device to engage said brake system of said motor vehicle into a braking mode, said switch device comprising a manual switch connected thereto for selective manual operation to inhibit said switch device and cut off delivery of said signal to said brake control device.

2. (canceled)

3. The safety system according to claim 1, wherein said distance detection device is based on one of the following means: CCD image capture, CMOS image capture, microwave radar distance measurement, supersonic distance measurement, and optical distance measurement.

4. The safety system according to claim 1, wherein said processing device produces a different signal in accordance with said distance to said obstacle.

5. (canceled)

6. The safety system according to claim 1, wherein said manual switch is connected to said brake system of said motor vehicle so that said manual switch is functional only when said brake system of said motor vehicle is engaged.

7. The safety system according to claim 1, wherein said brake control system engages said brake system of said motor vehicle into a different braking mode depending on said signal received from said processing device.

8. The safety system according to claim 7, wherein said braking mode is to brake said motor vehicle intermittently.

9. The safety system according to claim 7, wherein said braking mode is to brake said motor vehicle continuously.

10. The safety system according to claim 1, wherein said processing device is further connected to and is capable of blocking a signal from an accelerator pad signal source of said motor vehicle.

11. The safety system according to claim 10, wherein said signal from said accelerator signal source is blocked in an intermittent manner.

12. The safety system according to claim 10, wherein said signal from said accelerator signal source is blocked in a continuous manner.

13. The safety system according to claim 1, further comprising an audio device connected to said switch device wherein said audio device issues an alarming sound or a voice message upon receiving a signal from said processing device through said switch device.

14. The safety system according to claim 13, wherein said audio device varies said alarming sound or said voice message in accordance with said signal being received.
